(19) United States
(12) Patent Application Publication
(10) Pub. No.: US 2020/0097983 A1
(43) Pub. Date: Mar. 26, 2020

(54) SYSTEM AND METHOD FOR PROVIDING INFORMATION FOR AN ON-DEMAND SERVICE

(71) Applicant: BEIJING DIDI INFINITY TECHNOLOGY AND DEVELOPMENT CO., LTD., Beijing (CN)

(72) Inventors: Huan CHEN, Beijing (CN); Qi SONG, Beijing (CN); Junying ZHANG, Beijing (CN)

(73) Assignee: BEIJING DIDI INFINITY TECHNOLOGY AND DEVELOPMENT CO., LTD., Beijing (CN)

(21) Appl. No.: 16/695,249

(22) Filed: Nov. 26, 2019

Related U.S. Application Data
(63) Continuation of application No. PCT/CN2017/086300, filed on May 27, 2017.

(51) Int. Cl. G06Q 30/02; G06F 16/9535; G06F 16/909; H04L 29/08

(52) U.S. Cl. CPC G06Q 30/02; H04L 67/18; G06F 16/909; G06F 16/9535

(57) ABSTRACT

The present disclosure relates to a system, method and non-transitory computer readable medium. The system includes at least one computer-readable storage medium including a set of instructions and at least one processor in communication with the at least one computer-readable storage medium. When executing the set of instructions, the at least one processor is directed to: receive first electronic signals encoding a query and user information from a terminal; obtain one or more points of interest (POIs) based on the query; operate logic circuits in the at least one processor to obtain a ranking model; operate the logic circuits in the at least one processor to determine a ranking of the one or more POIs based on the ranking model and the user information; and generate second electronic signals encoding the one or more POIs in accordance with the ranking to send to the terminal in response to the query.

### CROSS-REFERENCE TO RELATED APPLICATIONS

This application is a continuation of International Application No. PCT/CN2017/086300, filed on May 27, 2017, the entire contents of which are incorporated herein by reference.

### TECHNICAL FIELD

The present disclosure relates generally to a system and method for providing information for an on-demand service, and in particular, to a system and method for providing a plurality of ranked locations in response to a query from a user of an on-demand service.

### BACKGROUND

On-demand services are becoming more and more popular. A user of on-demand services may search for a location by inputting a query using a mobile device. Quite often, the query for the location may generate multiple locations as results. The user may select one location that the user is interested in and initiate a service order (e.g., ordering a meal at a selected restaurant, taking a taxi to a selected music hall). It may be necessary to rank the multiple locations before providing at least part of the multiple locations based on the ranking to the user.

### SUMMARY

According to an aspect of the present disclosure, a system may include at least one computer-readable storage medium including a set of instructions and at least one processor in communication with the at least one computer-readable storage medium. When executing the instructions, the at least one processor is directed to: receive first electrical signals encoding a query and user information from a terminal; operate logical circuits in the at least one processor to obtain one or more points of interest (POIs) based on the query; operate the logical circuits in the at least one processor to obtain a ranking model; operate the logical circuits in the at least one processor to determine a ranking of the one or more POIs based on the ranking model and the user information; and generate second electrical signals encoding the one or more POIs in accordance with the ranking to send to the terminal in response to the query.

According to an aspect of the present disclosure, a method implemented on a computing device having at least one processor, at least one computer-readable storage medium, and a communication platform connected to a network may include: receiving first electronic signals encoding a query and user information from a terminal; operating logical circuits in the at least one processor to obtain one or more points of interest (POIs) based on the query; operating the logical circuits in the at least one processor to obtain a ranking model; operating the logical circuits in the at least one processor to determine a ranking of the one or more POIs based on the ranking model and the user information; and generating second electrical signals encoding the one or more POIs in accordance with the ranking to send to the terminal in response to the query.

According to an aspect of the present disclosure, a non-transitory computer readable medium may include instructions configured to cause at least one processor to: receive first electrical signals encoding a query and user information from a terminal; operate the logical circuits in the at least one processor to obtain one or more points of interest (POIs) based on the query; operate the logical circuits in the at least one processor to obtain a ranking model; operate the logical circuits in the at least one processor to determine a ranking of the one or more POIs based on the ranking model and the user information; and generate second electrical signals encoding the one or more POIs in accordance with the ranking to send to the terminal in response to the query.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates an exemplary network environment of providing an on-demand service, according to some embodiments;

FIG. 2 illustrates an exemplary computing device on which the on-demand service system can be implemented, according to some embodiments of the present disclosure;

FIG. 3 illustrates an exemplary mobile device on which the on-demand service can be implemented, according to some embodiments of the present disclosure;

FIG. 4 illustrates an exemplary processing engine, according to some embodiments of the present disclosure;

FIG. 5 illustrates an exemplary flowchart for determining a ranking of one or more POIs using the on-demand service system, according to some embodiments of the present disclosure; and

FIG. 6 illustrates an exemplary flowchart for determining a ranking model using the on-demand service system, according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of the present disclosure. It is to be expressly understood, however, that the drawings are for purposes of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to determining a ranking of at least one point of interest (POI) associated with a query of a transportation service, it should also be understood that the present disclosure is not intended to be limiting. The system or method of the present disclosure may be applied to any other kind of service. For example, the system or method of the present disclosure may be applied to search engines, digital map applications, navigation systems, etc. The search engines, digital map applications, or navigation systems may use the system of method provided herein to rank the search results, locations, or destinations, etc. As another example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system for management, for example, a system for sending and/or receiving an express. The application of the system or method of the present disclosure may be implemented on a user device and include a webpage, a plug-in of a browser, a client terminal, a custom system, an internal analysis system, an artificial intelligence robot, or the like, or any combination thereof.

The terms “passenger,” “requestor,” “service requestor,” and “user” in the present disclosure are used interchangeably to refer to an individual, an entity, or a tool that may request or order a service. Also, the term “driver,” “provider,” and “service provider” in the present disclosure are used interchangeably to refer to an individual, an entity, or a tool that may provide a service or facilitate the providing of the service.

The terms “service request,” “request for a service,” “requests,” “order,” and “service order” in the present disclosure are used interchangeably to refer to a request that may be initiated by a passenger, a service requestor, a user, a driver, a provider, a service provider, or the like, or any combination thereof. The service request may be accepted by any one of a passenger, a service requestor, a user, a driver, a provider, or a service provider. The service request may be chargeable or free.

The term “driver device” in the present disclosure is used to refer to a mobile terminal that is used by a service provider to provide a service or facilitate the providing of the service. The term “terminal device” in the present disclosure is used to refer to a mobile terminal that is used by a service requestor to request or order a service.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

According to an aspect of the present disclosure, a system and method for providing at least one ranked POI in response to a query are provided. The system obtains a query and user information from a mobile device of a user. The system obtains one or more POIs based on the query. The system further obtains a ranking model and determines a ranking of the one or more POIs based on the ranking model and the user information. The system transmits the ranking of the one or more POIs to the mobile device in response to the query. By ranking the one or more POIs using a trained ranking model, the system can provide the POIs in accordance with the user's interest. Thus, the efficiency of the transportation service is enhanced, and the user experience is also improved.

It should be noted that the information retrieval service in the present disclosure, which may be used in map applications, search engines, or on-demand services, such as online taxi hailing, is a newly emerged service rooted in post-Internet era. It provides the technical solutions to the users that could rise only in post-Internet era. In the pre-Internet era, when a passenger or traveler wants to obtain information related to a location, he/she may have to consult a local guide or look up a location in a local directory, which may be difficult to access. Besides, the local guide or the local directory may not have knowledge to provide comprehensive answers with respect to the entirety of the passenger's desired locations. Thus, passengers or travelers often have difficulties in searching for locations. However, the online information retrieval system is able to retrieve multiple POIs in response to a query of a user via a mobile device. The online information retrieval system determines a ranking of the plurality of POIs. The online information retrieval system transmits the ranked plurality of POIs in accordance with the ranking to the mobile device. The user only needs to browse and/or select a POI that he/she is interested based on the ranking. The user may initiate a service order after clicking the interested POI. By retrieving and ranking a plurality of POIs in response to a query of a user, the online information retrieval system may provide a convenient and efficient location search service to the user and enhance the user experience. Also, the process for generating a service order may be simplified and the time consumption for ordering the service may be reduced. Therefore, through Internet, the online information retrieval systems may provide a much more convenient and efficient transaction platform for the passengers that may never be met in a traditional pre-Internet scenario.

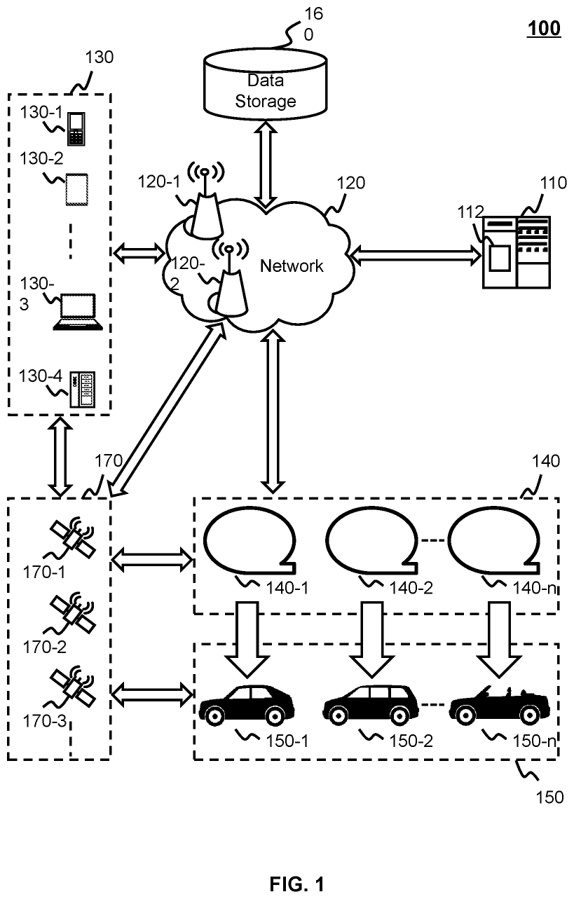

FIG. 1 illustrates an exemplary network environment of providing an on-demand service according to some embodiments. An on-demand service system 100 may be an online transportation service platform implemented in a network environment with a positioning system for providing transportation services. The on-demand service system 100 may include a server 110, a network 120, a terminal device 130, a driver device 140, a vehicle 150, and a data storage 160. The one-demand service system 100 may further communicately connect to a positioning system 170.

The on-demand service system 100 may provide a plurality of services. Exemplary on-demand service may include a taxi hailing service, a chauffeur service, an express car service, a carpool service, a bus service, a driver hire service, and a shuttle service. In some embodiments, an on-demand service may be provided with supplementary information recommended to perform the on-demand service. The order types may include a taxi order, a luxury car order, an express car order, a bus order, a shuttle order, etc. In some embodiments, the service may be any on-line service, such as booking a meal, shopping, or the like, or a combination thereof.

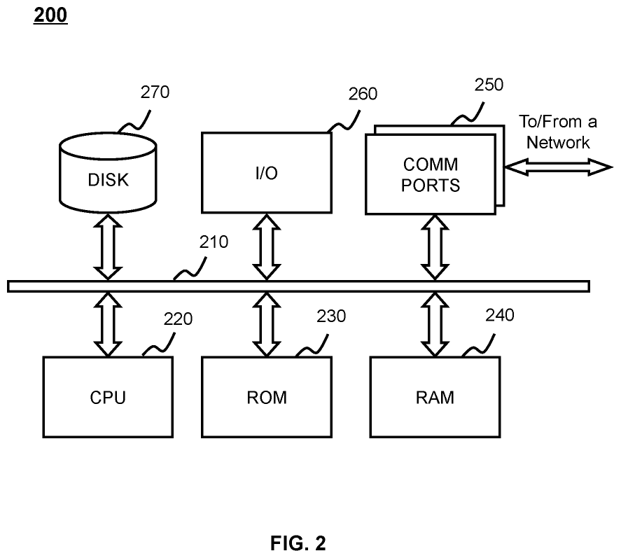

The server 110 may be a computer server. The server 110 may communicate with the terminal device 130 and/or the driver device 140 to provide various functionality of an online on-demand service. In some embodiments, the server 110 may be a single server, or a server group. The server group may be a centralized server group connected to the network 120 via an access point, or a distributed server group connected to the network 120 via one or more access points, respectively. In some embodiments, the server 110 may be locally connected to the network 120 or in remote connection with the network 120. For example, the server 110 may access information and/or data stored in the terminal device 130, the driver device 140, and/or the data storage 160 via the network 120. As another example, the data storage 160 may serve as backend data storage of the server 110. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data related to performing one or more functions described in the present disclosure. For example, the processing engine 112 may analyze a query from a terminal device 130. For example, the processing engine 112 may determine one or more POIs associated with the query. As another example, the processing engine 112 may determine a ranking of the one or more POIs associated with the query. In some embodiments, the processing engine 112 may include one or more processing units (e.g., single-core processing engine(s) or multi-core processing engine(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the on-demand service system 100 (e.g., the server 110, the terminal device 130, the driver device 140, the vehicle 150, the data storage 160) may send information and/or data to other component(s) in the on-demand service system 100 via the network 120. For example, the server 110 may access and/or obtain a plurality of POIs from the data storage 160 via the network 120. For example, the server 110 may transmit the ranking of the one or more POIs to the terminal device 130. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, a passenger may be an owner of the terminal device 130. In some embodiments, the owner of the terminal device 130 may be someone other than the passenger. For example, an owner A of the terminal device 130 may use the terminal device 130 to send a service request for a passenger B, and/or receive a service confirmation and/or information or instructions from the server 110. In some embodiments, a driver may be a user of the driver device 140. In some embodiments, the user of the driver device 140 may be someone other than the driver. For example, a user C of the driver device 140 may use the driver device 140 to receive a service request for a driver D, and/or information or instructions from the server 110. In some embodiments, a driver may be assigned to use one of the driver device 140 and/or one of the vehicles 150 for at least a certain period of time, for example, a day, a week, a month, or a year etc. In some other embodiments, a driver may be assigned to use one of the driver device 140 and/or one of the vehicles 150 on a random basis. For example, when a driver is available to provide an on-demand service, he/she may be assigned to use a driver terminal that receives the earliest request and a vehicle that is recommended to perform the type of on-demand service. In some embodiments, “passenger” and “terminal device” may be used interchangeably, and “driver” and “driver device” may be used interchangeably. In some embodiments, the driver device may be associated with one or more drivers (e.g., a night-shift driver, a day-shift driver, or a driver pool by a random shifting).

In some embodiments, the terminal device 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, a built-in device in the vehicle 130-4 may include a built-in computer, an onboard built-in television, a built-in tablet, etc. In some embodiments, the terminal device 130 may include a signal transmitter and a signal receiver configured to communicate with the positioning system 170 for locating the position of the passenger and/or the terminal device 130.

The driver device 140 may include a plurality of driver devices 140-1, 140-2, . . . , 140-n. In some embodiments, the driver device 140 may be similar to, or the same device as the terminal device 130. In some embodiments, the driver device 140 may be customized to implement the online transportation service. In some embodiments, the driver device 140 and the terminal device 130 may be configured with a signal transmitter and a signal receiver to receive position information of the driver device 140 and the terminal device 130 from the positioning system 170. In some embodiments, the terminal device 130 and/or the driver device 140 may communicate with other positioning device to determine the position of the passenger, the terminal device 130, the driver, and/or the driver device 140. In some embodiments, the terminal device 130 and/or the driver device 140 may periodically send the positioning information to the server 110. In some embodiments, the driver device 140 may also periodically send the availability status to the server 110. The availability status may indicate whether a vehicle 150 associated with the driver device 140 is available to transport a passenger. For example, the terminal device 130 may send the positioning information to the server 110 every thirty minutes. As another example, the driver device 140 may send the availability status to the server every thirty minutes, and/or upon an on-demand service is completed. As another example, the terminal device 130 may send the positioning information to the server 110 each time the user logs into the mobile application associated with the online on-demand service.

In some embodiments, the driver device 140 may correspond to one or more vehicles 150. The vehicles 150 may carry the passenger and travel to the destination. The vehicles 150 may include a plurality of vehicles 150-1, 150-2, . . . , 150-n. One of the plurality of vehicles may correspond to one order type. The order types may include a taxi order, a luxury car order, a limousine order, an express car order, a bus order, a shuttle order, etc.

The data storage 160 may store data and/or instructions. The data may include data related to a plurality of POIs, data related to a plurality of users, data related to a plurality of drivers, data related to external environment, etc. The data related to the POIs may include names of the POIs, descriptions of the POIs, locations of the POIs, comments of the POIs, ratings of the POIs, etc. The data related to the users may include user profiles. The data related to the drivers may include driver profiles. The data related to the external environment may include weather conditions, road conditions, etc. In some embodiments, the data storage 160 may store data obtained from the terminal device 130 and/or the driver device 140. For example, the data storage 160 may store log information associated with the terminal device 130. The data storage 160 may include one or more synonyms with respect to an object stored in the data storage 160. The one or more synonyms with respect to an object may be the synonymous descriptions of the object or one or more attributes or attractions associated with the object, etc. The one or more synonyms may include at least one language. For example, the synonyms of Washington DC may include the capital city of the United States, the District of Columbia, White House, Capitol Hill, a Chinese language of “Washington DC” etc. In some embodiments, the data storage 160 may store data and/or instructions that the server 110 may execute to provide the on-demand services described in the present disclosure. In some embodiments, data storage 160 may include a mass storage, a removable storage, a volatile read-and-write memory, a read-only memory (ROM), or the like, or any combination thereof. Exemplary mass storage may include a magnetic disk, an optical disk, a solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the data storage 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, one or more components in the on-demand service system 100 may access the data or instructions stored in the data storage 160 via the network 120. In some embodiments, the data storage 160 may be directly connected to the server 110 as a backend storage.

In some embodiments, one or more components in the on-demand service system 100 (e.g., the server 110, the terminal device 130, the driver device 140, etc.) may have permissions to access the data storage 160. In some embodiments, one or more components in the on-demand service system 100 may read and/or modify the information related to the passenger, the driver, and/or the vehicle when one or more conditions are met. For example, the server 110 may read and/or modify one or more passengers' user profile after an on-demand service order is completed.

The positioning system 170 may determine information associated with an object, for example, one or more of the terminal device 130, the driver device 140, the vehicle 150, etc. For example, the positioning system 170 may determine a current time and a current location of the terminal device 130. In some embodiments, the positioning system 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, and/or a current time. The location may be in the form of coordinates, such as, a latitude coordinate and a longitude coordinate, etc. The positioning system 170 may include one or more satellites, for example, a satellite 170-1, a satellite 170-2, and a satellite 170-3. The satellites 170-1 through 170-3 may determine the information mentioned above independently or jointly. The positioning system 170 may send the information mentioned above to the terminal device 130, the driver device 140, or the vehicle 150 via the network 120.

In some embodiments, information exchanging between one or more components of the on-demand service system 100 may be initiated by way of launching the mobile application of the on-demand services on a terminal device, requesting a service, or inputting a query via the terminal device (e.g., searching for a POI). The object of the service request may be any product. In some embodiments, the product may include food, medicine, commodity, chemical product, electrical appliance, clothing, car, housing, luxury, or the like, or any combination thereof. In some other embodiments, the product may include a service product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application related to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element of the on-demand service system 100 performs, the element may perform through electrical signals and/or electromagnetic signals. For example, when a terminal 130 processes a task, such as making a determination, ranking a plurality of POIs, the terminal 130 may operate logic circuits in its processor to process such task. When the terminal 130 sends out a query (e.g., information relating to a destination) to the server 110, a processor of the terminal 130 may generate electrical signals encoding the query. The processor of the terminal 130 may then send the electrical signals to an output port. If the terminal 130 communicates with the server 110 via a wired network, the output port may be physically connected to a cable, which further transmit the electrical signal to an input port of the server 110. If the terminal 130 communicates with the server 110 via a wireless network, the output port of the terminal 130 may be one or more antennas, which convert the electrical signals to electromagnetic signals. Similarly, a driver device 140 may process a task through operation of logic circuits in its processor, and receive an instruction and/or service order from the server 110 via electrical signals or electromagnet signals. Within an electronic device, such as the terminal 130, the driver device 140, and/or the server 110, when a processor thereof processes an instruction, sends out an instruction, and/or performs an action, the instruction and/or action is conducted via electrical signals. For example, when the processor retrieves data (e.g., a plurality of POIs associated with a query) from a storage medium (e.g., a data storage 160), it may send out electrical signals to a read device of the storage medium, which may read structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 illustrates an exemplary computing device 200 on which the on-demand service system can be implemented, according to some embodiments of the present disclosure.

The computing device 200 may be a general purpose computer or a special purpose computer. Both may be used to implement an on-demand system of the present disclosure. The computing device 200 may be used to implement any component of the service as described herein. For example, the processing engine 112 of the server may be implemented on the computing device 200, via its hardware, software program, firmware, or a combination thereof. Although only one such computer is shown for convenience, the computer functions related to the service as described herein may be implemented in a distributed manner on a number of similar platforms to distribute the processing load.

The computing device 200, for example, may include COM ports 250 connected to and from a network (e.g., the network 120) connected thereto to facilitate data communications. The computing device 200 may also include a central processing unit (CPU) 220, in the form of one or more processors, for executing program instructions. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or other type of non-transitory storage medium to be executed by the CPU 220. The methods and/or processes of the present disclosure may be implemented as the program instructions. The computing device 200 also includes an I/O component 260, supporting input/output between the computer, the user, and other components therein. The computing device 200 may also receive programming and data via network communications.

Merely for illustration, only one CPU and/or processor is described in the computing device 200. However, it should be noted that the computing device 200 in the present disclosure may also include multiple CPUs and/or processors, thus operations and/or method steps that are performed by one CPU and/or processor as described in the present disclosure may also be jointly or separately performed by the multiple CPUs and/or processors. For example, the CPU and/or processor of the computing device 200 may execute both step A and step B. As in another example, step A and step B may also be performed by two different CPUs and/or processors jointly or separately in the computing device 200 (e.g., the first processor executes step A and the second processor executes step B, or the first and second processors jointly execute steps A and B).

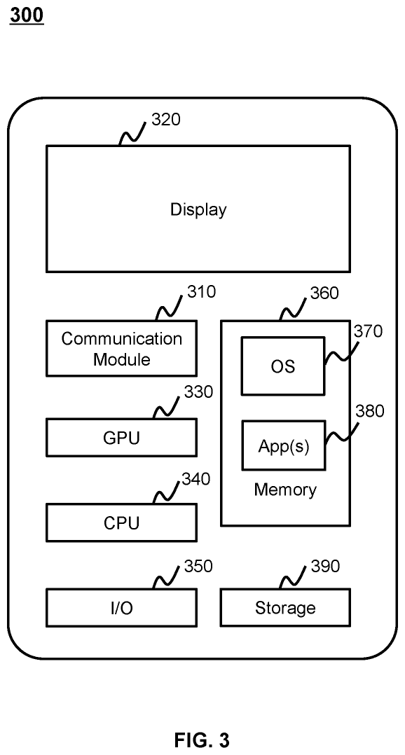

FIG. 3 illustrates an exemplary mobile device on which the on-demand service can be implemented, according to some embodiments of the present disclosure.

As illustrated in FIG. 3, the mobile device 300 may include a communication module 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for transmitting, receiving and presenting information relating to a service order (e.g., a plurality of POIs associated with a query) from the processing engine 112 and/or the data storage 160. User interactions with the information stream may be achieved via the I/O 350 and provided to the processing engine 112 and/or other components of the on-demand service system 100 via the network 120.

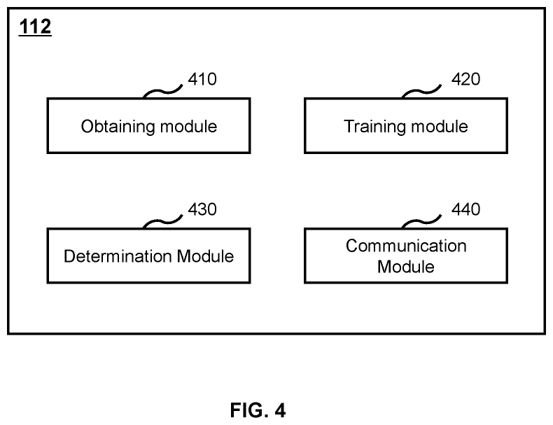

FIG. 4 illustrates an exemplary processing engine 112 according to some embodiments of the present disclosure. The processing engine 112 of the server 110 may include an obtaining module 410, a training module 420, a determination module 430, and a communication module 440. One or more modules in the processing engine 112 may be implemented by at least one processor, such as the CPU 220.

The obtaining module 410 may obtain a query and user information from one or more terminal devices 130. The query may refer to information related to an address (e.g., a start location, a destination). In some embodiments, the query may take the form of a character string, an image, an audio, etc. For example, the query may include a complete word or a phrase. As another example, the query may include partial inputs of a complete word or a phrase. As yet another example, the query may include a recorded audio signal via the microphone of a terminal device. The user information may refer to information related to a user. In some embodiments, the user information may include a geographical location of the terminal device 130, a user profile of the user associated with the terminal device 130, etc. The user profile may include, a gender of the user, an age of the user, a group in which the user is associated with (e.g., a student association, a salesman network, a registered attorney association in Beijing area, or any type of social network groups, etc.), or the like, or a combination thereof. In some embodiments, the query may be initiated by manipulating one or more items (icons, buttons, etc.) on a user interface of the service application. For example, the query may be initialed by inputting information via a virtual keyboard on the user interface or a physical keyboard.

The obtaining module 410 may further obtain one or more POIs based on the query. In some embodiments, the obtaining module 410 may obtain the one or more POIs from the data storage 160. The POI may include a name (e.g., Peking University, Peking Union Medical College Hospital), a type (e.g., a school, a hospital), an address (e.g., No. 9 Xuesen Road, Gaoxin District, Suzhou), coordinates (e.g., latitude coordinate and longitude coordinate), a zip code (e.g., 100000), a description, or the like, or the combination thereof. In some embodiments, the obtaining module 410 may further perform query parsing. The obtaining module 410 may determine one or more elements based on the query parsing. The obtaining module 410 may further obtain the one or more POIs based on the one or more elements.

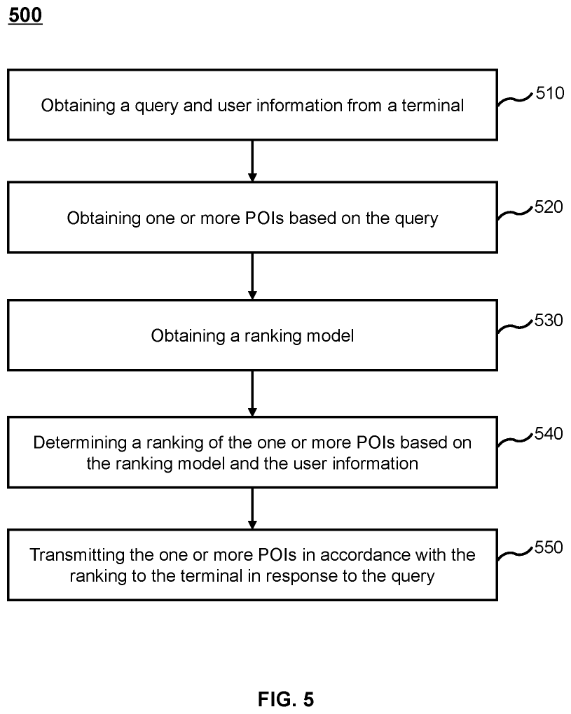

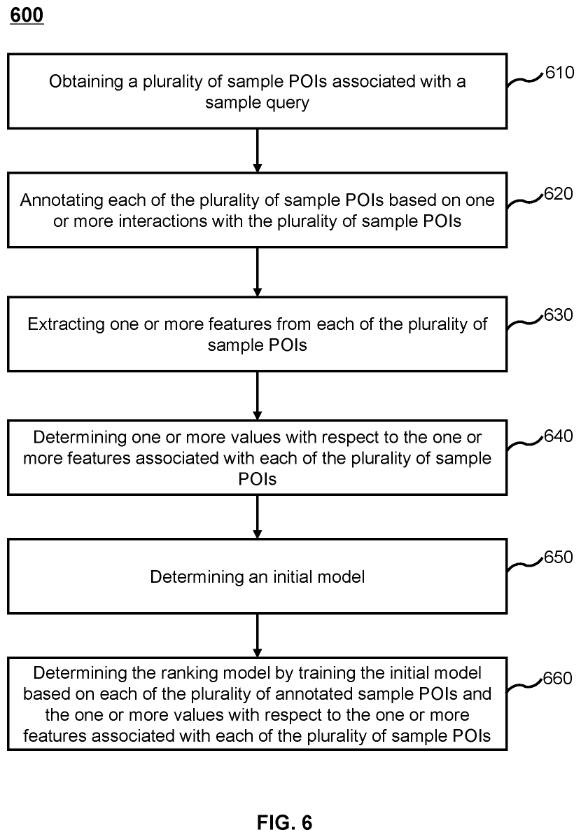

The training module 420 may obtain a ranking model. The ranking model may rank the one or more POIs associated with the query transmitted from the terminal device 130. The ranking model may include a learning to rank (LTR) model. In some embodiments, the ranking model may be obtained by training an initial model using a vast of training data. Details of the ranking model and the initial model will be described in connection with FIG. 5 and FIG. 6, and the description thereof.

The determination module 430 may determine a ranking of the one or more POIs. In some embodiments, the determination module 430 may determine the ranking based on relevance of the one or more POIs to the query. For example, the most relevant POI may be assigned as top ranking, and the least relevant POI may be assigned as bottom ranking. In some embodiments, the determination module 430 may determine the ranking based on the ranking model (e.g., acquired by the training module 420) and user information (e.g., acquired by the obtaining module 410).

The determination module 430 may determine one or more values corresponding to one or more features of one or more POIs. Merely by way of example, the one or more features may include a distance between the terminal device 130 and a POI, a correlation degree between a query and a POI, a click-through rate associated with a POI, a click count associated with a POI, etc. In some embodiments, the determination module 430 may determine a ranking of one or more POIs based on the one or more values corresponding to the one or more features of the one or more POIs.

The communication module 440 may transmit the one or more POIs in accordance with the ranking to the terminal device 130 in response to the query. In some embodiments, the communication module 440 may transmit all or part of the one or more ranked POIs. For example, the communication module 440 may transmit the top six POIs in the ranking to the terminal device 130.

The obtaining module 410, the training module 420, the determination module 430, and the communication module 440 in the processing engine 112 may be connected to or communicate with each other via a wired connection, a wireless connection, or any combination thereof. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the obtaining module 410, the training module 420, the determination module 430, and the communication module 440 may be combined as a single module. For example, the training module 420 may be integrated with the determination module 430 as a single module. The single module may determine a ranking model and determine a ranking of one or more POIs based on the ranking model.

FIG. 5 illustrates an exemplary flowchart 500 for determining a ranking of one or more POIs using the on-demand service system, according to some embodiments of the present disclosure. The flowchart 500 may be implemented as a set of instructions in a non-transitory storage medium of the server 110 of the system 100. The CPU 220 of the server 110 may execute the set of instructions and may accordingly perform the steps in the flowchart 500.

The operations of the illustrated flowchart 500 presented below are intended to be illustrative and not limiting. In some embodiments, the flowchart 500 may be accomplished with one or more additional operations not described, and/or without one or more of the operations discussed. Additionally, the order in which the operations of the flowchart 500 as illustrated in FIG. 5 and described below is not intended to be limiting.

In step 510, the obtaining module 410 may obtain a query and user information from a terminal device 130. The terminal device 130 may be owned and/or used by a user. In some embodiments, the query may take the form of a text, an image, an audio, etc. The query may include an address (e.g., a start location, a destination), a nearby area (e.g., the area of 5 kilometers from the user), a category of one or more POIs (e.g., a hotel, a shop, and a park), a zip code, etc. In some embodiments, the user information may include a geographical location of the terminal device 130, a user profile of the user, a current time, or the like, or a combination thereof. In some embodiments, the query may be initiated by inputting a character string on the user interface, inputting an audio via a microphone, taking a photo, etc.

In step 520, the obtaining module 410 may obtain one or more POIs based on the query.

In some embodiments, the obtaining module 410 may further perform query parsing. The query parsing may segment the query (e.g., a longer character string inputted by the user or converted from the audio inputted by the user) into one or more elements. Merely by way of example, a longer character string “Washington DC hotels with access to metro” may be segmented into three elements, “Washington DC”, “hotels” and “access to metro”. The obtaining module 410 may analyze the elements and determine an intention of the user.

The obtaining module 410 may further obtain the one or more POIs based on the one or more elements from the data storage 160. The names and/or descriptions of the one or more POIs may relate to the one or more elements. The POIs may be further determined in accordance with the interest of the user based on the obtained user information. For example, if the obtaining module 410 determines that the user likes have a drink after work, the POIs may be obtained from the category of “bar”. In some embodiments, the one or more POIs may be obtained from the data storage 160 based on the synonyms of the determined user interest.

In step 530, the training module 420 may obtain a ranking model. The ranking model may include a machine learning model. In some embodiments, the ranking model may include a LTR model. The ranking model may be a general ranking model trained using the training data collected from a vast group of users. In some embodiments, the ranking model may be a specific ranking model trained using designated training data associated with a user or a group of users. The ranking model may be trained in accordance with operations described in connection with FIG. 6.

In step 540, the determination module 430 may determine a ranking of the one or more POIs based on the ranking model and the user information. The determination module 430 may determine a plurality of values. Each value may relate to a feature with respect to a POI. The feature may include a distance between the terminal device 130 and the POI, a correlation degree between the POI and the query, a click-through rate (CTR) of the POI, a click count of the POI, etc.

The distance between the terminal device 130 and the POI may refer to a Euclidean distance, which may be determined based on the coordinates of geographical locations of the terminal device 130 and the POI. The distance may be further denoted as one or more measuring units, such as, the number of blocks, the travel time by walking, the travel time by driving, the arrival time by walking, the arrival time by driving, etc.

The correlation degree between the POI and the query may be determined based on a hit rate or the like. The query may be segmented to one or more elements after the query parsing. The hit rate may be determined based on a total number of the one or more elements in the query and a number of the elements shared by the query and a description of the POI. For example, if a query contains five elements and a description of a POI contains three of the five elements, the hit rate for the POI is 60%.

The click-through rate may refer to a ratio of a number of the clicks on a POI via a plurality of channels to the number of visits to the plurality of channels providing access links to the POI. The plurality of channels may include web pages, mobile applications, web advertisements, mobile application advertisements, etc. The click-through rate may be determined based on historical queries, historical POIs in response to the historical queries, and historical clicks. The historical queries, the historical POIs, and the historical clicks may be within a period of time (e.g., three months, six months, or a year) from the current time.

The click count may refer to the number of the clicks on a POI provided via a plurality of channels, for example, web pages, mobile applications, web advertisements, mobile application advertisements, etc. The click count may be determined based on historical queries, historical POIs in response to the historical queries, and historical clicks. The historical clicks may be within a period of time (e.g., three months, six months, or a year) from the current time.

In some embodiments, the determination module 430 may determine a value of the correlation degree between a POI and a query. The value of the correlation degree may be determined based on a hit rate of the POI with respect to the query.

In some embodiments, the determination module 430 may determine a value of the click-through rate of a POI. The value corresponding to the click through rate may be determined based on the user profile (e.g., a gender of a user, an age of the user, a group in which the user is associated with, etc.). For example, the determination module 430 may determine the click-through rate of a POI with respect to a special group that the user is associated with.

In some embodiments, the determination module 430 may determine a value of the click count of a POI. The value corresponding to the click count may be determined based on the user profile (e.g., a gender of a user, an age of the user, a group in which the user is associated with, etc.). For example, the determination module 430 may determine the click count of a POI with respect to a special group that the user is associated with.

In some embodiments, the determination module 430 may determine a value of the distance between the terminal device 130 and a POI. The distance may be determined based on user information (e.g., a geographical location of the terminal device 130). For example, the determination module 430 may determine the distance based on the geographical location of the terminal device 130 and the geographical location of the POI.

The determination module 430 may determine the ranking of the one or more POIs based on the plurality of values with respect to the one or more features. In some embodiments, the determination module 430 may determine the relevance of the one or more POIs to the query based on the plurality of values. For example, the relevance of a POI to the query may be determined as high when one or more values corresponding to one or more features with respect to the POI are high. As another example, the relevance of a POI to the query may be determined as lower when a distance between the terminal device 130 and the POI is shorter than a predetermined distance (e.g., 500 meters). When the distance between the terminal device 130 and the POI is relatively short, the user may prefer walking to the POI instead of taking a taxi to the POI. In some embodiments, the determination module 430 may determine the ranking based on the relevance of the one or more POIs to the query. For example, the determination module 430 may assign a POI with the highest relevance to a top ranking.

In step 550, the communication module 440 may transmit the one or more POIs in accordance with the ranking to the terminal device 130 in response to the query. In some embodiments, the communication module 440 may transmit all or part of the one or more POIs in the ranking to the terminal device 130. For example, the communication module 440 may transmit the top six POIs in the ranking to the terminal device 130.

In some embodiments, the flowchart 500 may further include additional steps. The obtaining module 410 may receive a service order generated in response to a selection of one of the one or more POIs from the terminal device 130. The user associated with the terminal device 130 may select one of the one or more POIs as a destination. The user may determine a service order based on the selection and transmit the service order to the obtaining module 410. In some embodiments, the user may perform the selection by clicking a POI.

The above description is merely for illustrative purposes. It should be noted that those skilled in the art may contemplate additional or alternative steps besides the steps described in FIG. 5.

FIG. 6 illustrates an exemplary flowchart 600 for determining a ranking model using the on-demand service system, according to some embodiments of the present disclosure. The flowchart 600 may be implemented as a set of instructions in a non-transitory storage medium of the server 110 of the system 100. The CPU 220 of the server 110 may execute the set of instructions and may accordingly perform the steps in the flowchart 600.

The operations of the illustrated flowchart 600 presented below are intended to be illustrative. In some embodiments, the flowchart 600 may be accomplished with one or more additional operations not described, and/or without one or more of the operations discussed. Additionally, the order in which the operations of the flowchart 600 as illustrated in FIG. 6 and described below is not intended to be limiting.

In step 610, the training module 420 may obtain a plurality of sample POIs associated with a sample query. The training module 420 may perform a query parsing on the sample query and generate one or more elements. The training module 420 may further obtain the plurality of sample POIs from the data storage 160 based on the one or more elements with respect to the query. For example, the training may obtain a POI including at least one of the one or more elements.

In step 620, the training module 420 may annotate each of the plurality of sample POIs based on one or more user interactions with the plurality of sample POIs. The user interaction may include a click on a sample POI, a service order associated with the clicked sample POI, or the like, or a combination thereof. In some embodiments, the training module 420 may detect one or more user interactions associated with each of the plurality of sample POIs. The training module 420 may further annotate each of the plurality of sample POIs with a pre-determined value based on the detected user interaction. The pre-determined value may indicate a user's interest in the sample POI. In some embodiments, the pre-determined value may be 0, 1, or any other number. The value “1” may indicate the relevance between the sample query and a sample POI is relatively high. The value “0” may indicate that the relevance between the sample query and a sample POI is relatively low.

For example, in response to detecting a click on a sample POI, the training module 420 may annotate the sample POI with “1” and annotate other sample POIs with “0”. As another example, in response to detecting a service order associated a selected sample POI, the training module 420 may annotate the selected sample POI with “1”. The training module 420 may annotate other sample POIs with “0”.

In step 630, the training module 420 may extract one or more features from each of the plurality of sample POIs. In some embodiments, the one or more feature may include a distance between the terminal device 130 and a sample POI, a correlation degree between the sample POI and the sample query, a click-through rate (CTR) of the sample POI, a click count of the sample POI, etc.

In step 640, the training module 420 may determine one or more values with respect to the one or more features associated with each of the plurality of sample POIs. Each of the one or more values may correspond to one feature. In some embodiments, the training module 420 may determine a value of the correlation degree between a sample POI and the sample query. The training module 420 may determine the value based on a hit rate. In some embodiments, the training module 420 may determine a value of the click-through rate of the sample POI. The training module 420 may determine the value based on a historical click-through rate of the sample POI. The value corresponding to the click-through rate may be determined corresponding to different groups of users. The different groups may be divided based on the user profile information including a gender, an age, etc. In some embodiments, the training module 420 may determine a value of the click count of the sample POI. The training module 420 may determine the value based on a historical click count of the sample POI. The value corresponding to the click count may be determined corresponding to different groups of users. The different groups may be based on the user profile information including a gender, an age, etc. In some embodiments, the training module 420 may determine a value of the distance between a sample terminal device 130 and the sample POI. A user of the sample terminal may input the sample query via the sample terminal.

In step 650, the training module 420 may determine an initial model. The initial model may include a Ranking Support Vector Machine (SVM) model, a RankBoost model, a LambdaMART model, an AdaRank model, a SoftRank model, etc. The initial model may have more than one initial parameter.

In step 660, the training module 420 may determine the ranking model by training the initial model based on each of the plurality of annotated sample POIs and the one or more values with respect to the one or more features associated with each of the plurality of sample POIs. The initial model may take the one or more values as input and determine an actual ranking of the sample POIs as an actual output. The training module 420 may determine a desired output based on the plurality of annotated sample POIs. The training module 420 may train the initial model to minimize a loss function. The loss function may indicate a difference between the desired output and the actual output determined by the initial model. A sample POI may have an actual order in the actual output and a desired order in the desired output. The actual order and the desired order may be the same or different. The loss function may be a sum of the absolute differences between the actual order and the desired order for each of the sample POI. Specifically, when the actual output is identical to the desired output, the loss function is 0. The minimization may be iterative. The iteration of the minimization of the loss function may end when the value of the loss function is less than a predetermined threshold. The predetermined threshold may be set based on various factors, including a number of the sample POIs, an accuracy of the ranking model, etc. The training module 420 may iteratively adjust the initial parameters of the initial model during the minimization of the loss function. At the end of the minimization of the loss function, the training module 420 may determine more than one final parameter and the ranking model.

The above description is merely for illustrative purposes. It should be noted that those skilled in the art may contemplate additional or alternate steps besides the steps described in FIG. 6. For example, the flowchart 600 may further include transmitting the ranking model to the data storage 160 or any other components in the on-demand service system 100 by the communication module 440.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by the present disclosure, and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device” or “system.” Furthermore, aspects of the present disclosure may take the form of a computer program product embodied in one or more non-transitory computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter lie in less than all features of a single foregoing disclosed embodiment.

1. A system, comprising:
at least one storage medium including a set of instructions; and
at least one processor in communication with the at least one storage medium, wherein when executing the set of instructions, the at least one processor is directed to:
receive first electrical signals encoding a query and user information from a terminal;
operate logical circuits in the at least one processor to obtain one or more points of interest (POIs) based on the query;
operate the logical circuits in the at least one processor to obtain a ranking model;
operate the logical circuits in the at least one processor to determine a ranking of the one or more POIs based on the ranking model and the user information; and
generate second electrical signals encoding the one or more POIs in accordance with the ranking to send to the terminal in response to the query.

2. The system of claim 1, wherein the at least one processor is further directed to:
receive third electrical signals encoding a service order generated in response to a selection of one of the one or more POIs from the terminal.

3. The system of claim 1, wherein the user information includes at least one of a geographical location of the terminal and a user profile of the user associated with the terminal.

4. The system of claim 3, wherein the ranking of the one or more POIs is determined based on at least one of:
a correlation degree between the query and each of the one or more POIs;
a click-through rate (CTR) associated with each of the one or more POIs;
a click count associated with each of the one or more POIs; or
a distance between the geographical location of the terminal and each of the one or more POIs.

5. The system of claim 1, wherein to obtain the ranking model, the at least one processor is directed to:
operate the logical circuits in the at least one processor to obtain a plurality of sample POIs associated with a sample query;
operate the logical circuits in the at least one processor to annotate each of the plurality of sample POIs based on one or more user interactions with the plurality of sample POIs;
operate the logical circuits in the at least one processor to extract one or more features from each of the plurality of sample POIs;
operate the logical circuits in the at least one processor to determine one or more values with respect to the one or more features associated with each of the plurality of sample POIs;
operate the logical circuits in the at least one processor to determine an initial model; and
operate the logical circuits in the at least one processor to determine the ranking model by training the initial model based on each of the plurality of annotated sample POIs and the one or more values with respect to the one or more features associated with each of the plurality of sample POIs.

6. The system of claim 5, wherein the one or more features include at least one of a distance between a sample terminal from which the sample query is generated and one of the plurality of sample POIs, a correlation degree between the one of the plurality of sample POIs and the sample query, a click-through rate (CTR) of the one of the plurality of sample POIs, and a click count of the one of the plurality of sample POIs.

7. The system of claim 5, wherein to annotate each of the plurality of sample POIs based on one or more user interactions with the plurality of sample POIs, the at least one processor is directed to:
operate the logical circuits in the at least one processor to detect the one or more user interactions with the plurality of sample POIs; and
operate the logical circuits in the at least one processor to annotate one of the plurality of sample POIs with a pre-determined value in response to the detection of at least one user interaction with the one of the plurality of sample POIs.

8. A method implemented on a computing device having at least one processor, at least one computer-readable storage medium, and a communication platform connected to a network, comprising:
receiving first electrical signals encoding a query and user information from a terminal; operating logical circuits in the at least one processor to obtain one or more points of interest (POIs) based on the query;
operating the logical circuits in the at least one processor to obtain a ranking model;
operating the logical circuits in the at least one processor to determine a ranking of the one or more POIs based on the ranking model and the user information; and
generate second electrical signals encoding the one or more POIs in accordance with the ranking to send to the terminal in response to the query.

9. The method of claim 8, further comprising:
receiving third electrical signals encoding a service order generated in response to a selection of one of the one or more POIs from the terminal.

10. The method of claim 8, wherein the user information includes at least one of a geographical location of the terminal and a user profile of the user associated with the terminal.

11. The method of claim 10, wherein the ranking of the one or more POIs is determined based on at least one of:
a correlation degree between the query and each of the one or more POIs;
a click-through rate (CTR) associated with each of the one or more POIs;
a click count associated with each of the one or more POIs; or
a distance between the geographical location of the terminal and each of the one or more POIs.

12. The method of claim 8, wherein obtaining the ranking model comprises:
operating the logical circuits in the at least one processor to obtain a plurality of sample POIs associated with a sample query;
operating the logical circuits in the at least one processor to annotate each of the plurality of sample POIs based on one or more user interactions with the plurality of sample POIs;
operating the logical circuits in the at least one processor to extract one or more features from each of the plurality of sample POIs;
operating the logical circuits in the at least one processor to determine one or more values with respect to the one or more features associated with each of the plurality of sample POIs;
operating the logical circuits in the at least one processor to determine an initial model; and
operating the logical circuits in the at least one processor to determine the ranking model by training the initial model based on each of the plurality of annotated sample POIs and the one or more values with respect to the one or more features associated with each of the plurality of sample POIs.

13. The method of claim 12, wherein the one or more features include at least one of a distance between a sample terminal from which the sample query is generated and one of the plurality of sample POIs, a correlation degree between the one of the plurality of sample POIs and the sample query, a click-through rate (CTR) of the one of the plurality of sample POIs, and a click count of the one of the plurality of sample POIs.

14. The method of claim 12, wherein annotating the each of the plurality of sample POIs comprises:
operating the logical circuits in the at least one processor to detect the one or more user interactions with the plurality of sample POIs; and
operating the logical circuits in the at least one processor to annotate one of the plurality of sample POIs with a pre-determined value in response to the detection of at least one user interaction with the one of the plurality of sample POIs.

15. A non-transitory computer readable medium embodying a computer program product, the computer program product comprising instructions configured to cause at least one processor to:
receive first electrical signals encoding a query and user information from a terminal;
operate logical circuits in the at least one processor to obtain one or more points of interest (POIs) based on the query;
operate the logical circuits in the at least one processor to obtain a ranking model;
operate the logical circuits in the at least one processor to determine a ranking of the one or more POIs based on the ranking model and the user information; and
generate second electrical signals encoding the one or more POIs in accordance with the ranking to send to the terminal in response to the query.

16. The non-transitory computer readable medium of claim 15, wherein the computer program product further comprises instructions configured to cause the at least one processor to:
receive third electrical signals encoding a service order generated in response to a selection of one of the one or more POIs from the terminal.

17. The non-transitory computer readable medium of claim 15, wherein the user information includes at least one of a geographical location of the terminal and a user profile of the user associated with the terminal.

18. The non-transitory computer readable medium of claim 17, wherein the ranking of the one or more POIs is determined based on at least one of:
a correlation degree between the query and each of the one or more POIs;
a click-through rate (CTR) associated with each of the one or more POIs;
a click count associated with each of the one or more POIs; or
a distance between the geographical location of the terminal and each of the one or more POIs.

19. The non-transitory computer readable medium of claim 15, wherein the computer program product further comprises instructions configured to cause the at least one processor to:
operate the logical circuits in the at least one processor to obtain a plurality of sample POIs associated with a sample query;
operate the logical circuits in the at least one processor to annotate each of the plurality of sample POIs based on one or more user interactions with the plurality of sample POIs;
operate the logical circuits in the at least one processor to extract one or more features from each of the plurality of sample POIs;
operate the logical circuits in the at least one processor to determine one or more values with respect to the one or more features associated with each of the plurality of sample POIs;
operate the logical circuits in the at least one processor to determine an initial model; and
operate the logical circuits in the at least one processor to determine the ranking model by training the initial model based on each of the plurality of annotated sample POIs and the one or more values with respect to the one or more features associated with each of the plurality of sample POIs.

20. The non-transitory computer readable medium of claim 19, wherein the one or more features include at least one of a distance between a sample terminal from which the sample query is generated and one of the plurality of sample POIs, a correlation degree between the one of the plurality of sample POIs and the sample query, a click-through rate (CTR) of the one of the plurality of sample POIs, and a click count of the one of the plurality of the sample POIs.
